(19) United States
(12) Patent Application Publication
(10) Pub. No.: US 2014/0032636 A1
(43) Pub. Date: Jan. 30, 2014

(54) Methods and Systems for Streaming, and Presenting, Digital Media Data

(71) Applicant: David A. Nelson, San Francisco, CA (US)

(72) Inventor: David A. Nelson, San Francisco, CA (US)

(73) Assignee: Adobe Systems Incorporated, San Jose, CA (US)

(21) Appl. No.: 12/467,934

(22) Filed: May 18, 2009

(51) Int. Cl. G06F 15/16

(52) U.S. Cl. 709/203; 709/231; 709/228

(57) ABSTRACT

Computer-based methods and systems for streaming, and presenting, digital media data are presented. In some embodiments, a media server is configured to intelligently stream, or resume the streaming, of digital media data, representing a media item, based in part on device attributes of the media player device on which the media item is to be presented, as well as historical information about a user's prior viewing sessions, and location information indicating the current location of one or more media player devices of the user. Additionally, in some embodiments, the media server is configured to leverage multiple devices, when the devices are in proximity of one another, for example, by providing a control interface on a first device, that enables control of play back functions for media data being streamed to and presented on a second device.

### TECHNICAL FIELD

The present disclosure generally relates to media servers and media players for streaming and presenting media data, respectively. More specifically, the present disclosure relates to methods and systems for intelligently presenting media data on devices with varying device attributes and using distributed software to leverage the display of a first device for presenting a user interface for use with a media player application presenting media data on a second device.

### BACKGROUND

People are increasingly consuming digital media data on computing devices. Additionally, the variety of computing devices, as well as the capabilities of those devices on which digital media data is being consumed, is constantly changing. For example, it is not uncommon for a person to have, for consuming digital media data, a television or display in a living room, a desktop computer in an office, a laptop or notebook computer for traveling, a “smart” phone, a portable media player for viewing or listening to video and audio, and a digital book reader device for reading electronic books, and so on.

With so much digital media data available for consumption, and so many devices available for consuming digital media data, compatibility issues often arise. One type of compatibility problem occurs when a computing device does not support a particular type of media storage device on which media data is stored. For instance, to decrease weight and cost, certain classes of laptop or notebook computers are not equipped with optical disc drives capable of playing digital media data stored on popular disc formats, such as compact discs (CD's), digital video discs (DVD's), or Blu-ray discs. Of course, mobile handsets or phones generally are not equipped with optical disc drives either. Another compatibility problem occurs when the digital media data is in a format that is not supported, or is not optimal, for the device on which it is being presented. For instance, streaming a video in full high definition format (e.g., 1080P) to a mobile handset with a limited display resolution (e.g., 360 by 640) is problematic for a number of reasons. Similarly, using a high definition display to view a low resolution image that has been formatted for optimal display on a mobile handset is generally undesirable as well.

Another problem that is at least partly caused by having so many devices on which to consume digital media data is interruptions. For instance, with mobile devices, such as laptop or notebook computers, smart phones, and personal media players, people are able to consume digital media data at any time, including while they are on the move, for example, riding the bus or train, on a lunch break, waiting to board an airplane, and so on. As a consequence, a person may not view a particular media item (e.g., movie, home video, instructional video) from its beginning, through to its end, in one uninterrupted viewing session. For example, a person may insert a DVD in his laptop computer and begin watching a movie on his or her laptop while riding the train home from work. After dinner, the person might settle in on his or her sofa couch to watch the movie on a large flat panel display (possibly connected to a set-top box). Of course, because the person has seen the beginning portion of the movie while on the train, he or she will have to fast forward to the last scene that he or she watched, in order to resume from the point where he or she left off viewing the video on the train. Fast forwarding to, or, searching the video for a particular scene, takes time and frequently causes frustration.

Furthermore, if the large flat panel display supports a better format of the movie than what is stored on the DVD disc, the person will generally be limited in what is available for viewing by the format of the digital media data stored on the DVD. That is, the DVD contains one format of the movie, and that format is used for presenting the movie on all of the person's devices, regardless of the specific device attributes and capabilities of the individual devices.

Finally, some digital media player devices provide rather limited and difficult to use operational controls. For example, a typical desktop or laptop computer has a keyboard and mouse. Unfortunately, these input devices are not specifically designed for use with a media player application. Therefore, the keys of the keyboard assigned to control various play back functions may not be intuitive to use. Moreover, if a person is viewing a particular media item on the display of a desktop or laptop computer, the display is generally not available for other purposes. For instance, while viewing a movie, if a user desires to perform an information search about some aspect of the movie being viewed, or to search for a different movie to view, the person typically has to open a new window, thereby resizing (i.e., decreasing the size of) the window in which the movie is being presented.

### SUMMARY

Computer-based methods and systems for streaming, and presenting, digital media data are described. In some example embodiments, a media server is configured to stream media data to any number of media player devices having a wide variety of device attributes. For instance, upon receiving a request for a media item, the media server identifies the device attributes of the media player device to which the media item is to be streamed (e.g., the target device), and converts source digital media data to a format that is suitable for streaming to, and presenting at, the target media player device. In some embodiments, the media server includes a history information module for storing and analyzing historical information, including information about a user's prior streaming and/or viewing sessions. In addition, some embodiments include a location information module for receiving, storing, and analyzing location information indicating the current location of certain media player devices. By analyzing past streaming and/or viewing sessions as well as location information of media player devices, the media server is able to intelligently resume the streaming of media data, representing a media item, when an interruption occurs during a viewing session, and/or when circumstances change such that a user arrives in a new location having a “better” media player device, such as a media player device with a higher native display resolution and/or better audio support.

Additionally, in some embodiments, the location information module of the media server operates in conjunction with an ancillary media data module to communicate ancillary media data for presentation on a display of a secondary device. For instance, in certain scenarios, when a user has multiple media player devices in proximity with one another, one or more of the devices may be used to present ancillary media data having some association with, or relationship to, media data that is being streamed to and presented on another device (e.g., the primary viewing device). The ancillary media data may, for example, provide additional information about what is being presented on the primary viewing device, or in some cases, the ancillary media data may include a control interface, enabling control of play back functions for the media item being presented on the primary viewing device.

Other aspects of the invention will become apparent from the detailed description that follows.

### DESCRIPTION OF THE DRAWINGS

Some embodiments are illustrated by way of example and not limitation in the figures of the accompanying drawings, in which:

FIG. 1 is a block diagram showing an example of several computing devices (e.g., media player devices) that a user may utilize to display, and view, digital media data streamed from a media server, according to an embodiment of the invention;

FIG. 2 is a block diagram illustrating one example (e.g., a use case) of how a media server operates and interacts with various media player devices, consistent with an embodiment of the invention;

FIG. 3 is a functional block diagram of a media server 20 according to an embodiment of the invention;

FIG. 4 is a block diagram illustrating various components involved in streaming media data to computing devices, according to an embodiment of the invention;

FIG. 5 is a block diagram illustrating various functional components of a media player device, according to an embodiment of the invention;

FIG. 6 is a flow diagram illustrating a method, according to an embodiment of the invention, for streaming digital media; and

FIG. 7 is a block diagram of a machine in the form of a computing device within which a set of instructions, for causing the machine to perform any one or more of the methodologies discussed herein, may be executed.

### DETAILED DESCRIPTION

Methods and systems for streaming, presenting, and controlling the presentation of, digital media data are disclosed. In the following description, for purposes of explanation, numerous specific details are set forth in order to provide a thorough understanding of example embodiments. It will be evident, however, to one skilled in the art that the present invention may be practiced without these specific details.

For purposes of the present disclosure, the term, “digital media data” or simply “media data” includes data encoded in a particular format to represent audio information, image information (e.g., graphics, photographs or video) or a combination of audio and image information. For instance, in one example, digital media data may include the audio and video information representing a movie, or motion picture. Similarly, the term “source media data” refers to the copy or version of media data stored at a media server that can be streamed to one or more media player devices. In general, media data may represent a music video, home video, audio track (e.g., recorded song, speech, audio book), digital magazine or book, and so on. As used herein, the term “media item” is meant to represent a collection of media data, which, when streamed to a device, rendered and presented, represents a particular movie, music video, home video, audio track, digital magazine, digital book, or similar composition of audio and/or image information. For instance, it will be readily appreciated that the media item with title, “Gone with the Wind,” represents a collection of media data embodying the movie by the same name.

Consistent with some embodiments of the invention, a media server is accessible over a network by computing devices (referred to herein as media player devices) with widely varying device attributes. For instance, the device attributes of the media player devices that may vary widely include, but are not limited to, display or screen resolution, processing capabilities, communication capabilities, codecs, and so forth. The media server is capable of processing source digital media data to transform or convert the source digital media data to a format suitable for streaming to, and presentation on, the widely varying media player devices. For example, upon receiving a request for a particular media item, the media server analyzes the request to determine the best format to be used when streaming the media data, representing the requested media item, to the requesting device or some other target device. In some embodiments, each media player device has, or is associated with, a device profile, which, in some embodiments, is identified by a device identifier. Accordingly, a request communicated from a media player device to the media server may include the device identifier of the requesting media player device, or the target device, where the media data is to be presented. Based on this device identifier, the media server analyzes a device profile, which, in some embodiments, is implemented in the form of a device attribute matrix. By analyzing the device attribute matrix, the media server can identify the device attributes of the requesting media player device or target device, and transform or convert the source digital media data to a format best suited for the requesting media player device. In particular, the digital media data may be formatted to accommodate both the network connection type (e.g., speed and bandwidth) connecting the media server to the media player device, and various device attributes (e.g., display resolution, and available codecs) of the media player device.

In some embodiments of the invention, the media server stores information about a user, including information about the various media player devices owned and/or operated by the user. Additionally, in some embodiments, the media server may monitor the location of certain mobile media player devices, for example, by receiving location information from the mobile media player devices. The media server can analyze how a user is using his or her media player devices, and adapt its behavior accordingly. For instance, the media server may, in some embodiments, analyze what media items are being requested, when the media items are being requested, where the user is when requesting and viewing media items, and on what particular device(s) the media items are being requested, and so forth. Based on this information, the media server can adapt its behavior. For example, if a user is viewing a movie on his mobile handset while traveling on a train at a particular time of the day (e.g., commuting home from work), when the user enters his or her home, the media server may recognize the user's new location and automatically begin streaming the movie, in a higher quality format, to the user's large flat panel display (or connected set-top box). The media server may communicate a message to the user on his or her mobile handset, for example, to prompt the user to accept the change in streaming devices (e.g., from the mobile handset to the large flat panel display), or simply to notify the user of the change. Additionally, the media server may communicate to the mobile handset additional data representing a user interface that is in some manner connected with the presentation of the movie on the large flat panel display. For instance, the user interface may provide ancillary media data describing one or more aspects of what is being presented on the large flat panel display. For instance, in the case of a movie, the user interface may provide information about the actors in the movie, and so forth. Other aspects of the invention are described below in connection with the description of the figures.

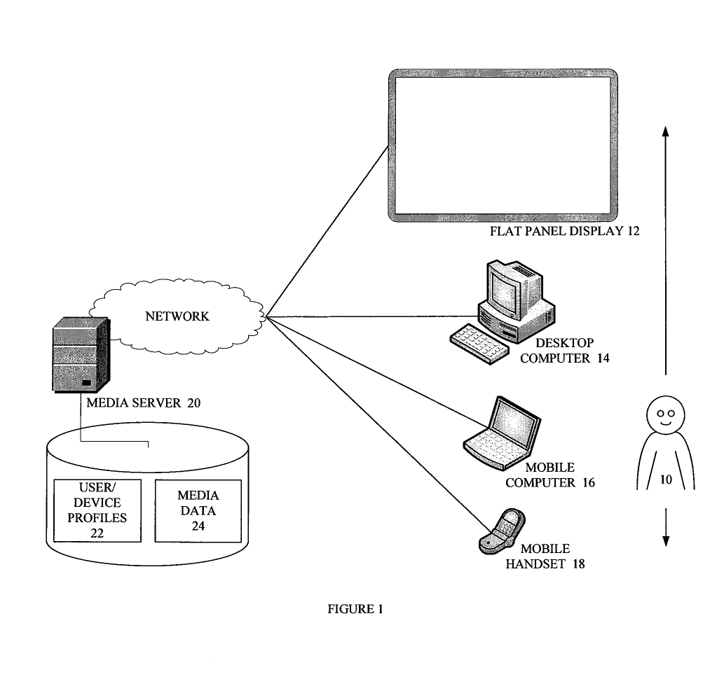

FIG. 1 is a block diagram showing an example of several computing devices (e.g., media player devices) that a user may utilize to display, and view, digital media data streamed from a media server, according to an embodiment of the invention. As illustrated in FIG. 1, the user 10 has a variety of computing devices configured to operate as media player devices. Specifically, the devices include a flat panel display 12, a desktop computer 14, a mobile computer 16 and a mobile handset 18. In this example, each computing device includes a processor, memory, and a networking or communications component (and other hardware components) operable to execute software instructions to receive and present digital media data, and perform the various methodologies described herein. The flat panel display 12, in some embodiments, may be connected to a set-top box, which provides the various hardware components described above. Furthermore, the user 10 may have one or more other devices (not shown) known to the media server, on which digital media data may be presented.

It will be readily appreciated that the various devices illustrated in FIG. 1 may have widely varying device attributes. Device attributes include both software, and hardware attributes. For instance, the desktop computer 14 may have a multi-core processor that executes a greater number of instructions per second than the processor of the mobile handset 18. Similarly, the native display resolution of the various devices may differ. The codecs used to decode digital media data streamed to a device may vary amongst the devices. Some devices may have integrated graphics capabilities, while others include a dedicated graphics processing unit. The network communication protocols supported by the various devices may vary from device to device. Some devices may have support for one or more wireless and/or mobile data communication protocols, including (but not limited to): Bluetooth, WiFi, 3G, 4G, GSM, CDMA, and so forth. In addition to, or instead of wireless communications, some devices may support one or more wired communication protocols, such as Ethernet, or Universal Serial Bus (USB) connections.

In some embodiments, in addition to storing media data 24, the media server 20 stores information 22 about each user of the media server, as well as information about the various devices that each user owns and/or utilizes with the media server 20. For example, in one embodiment, a user may have a user profile including a username and password to identify the user and authenticate the user with the media server 20. For each device a user utilizes with the media server 20, there is a device identifier and corresponding device profile associated with the user's user profile. Each device profile includes information about the various device attributes that are supported by the device. As described in greater detail below, in some embodiments, the device profiles for a user are implemented as a device attribute matrix.

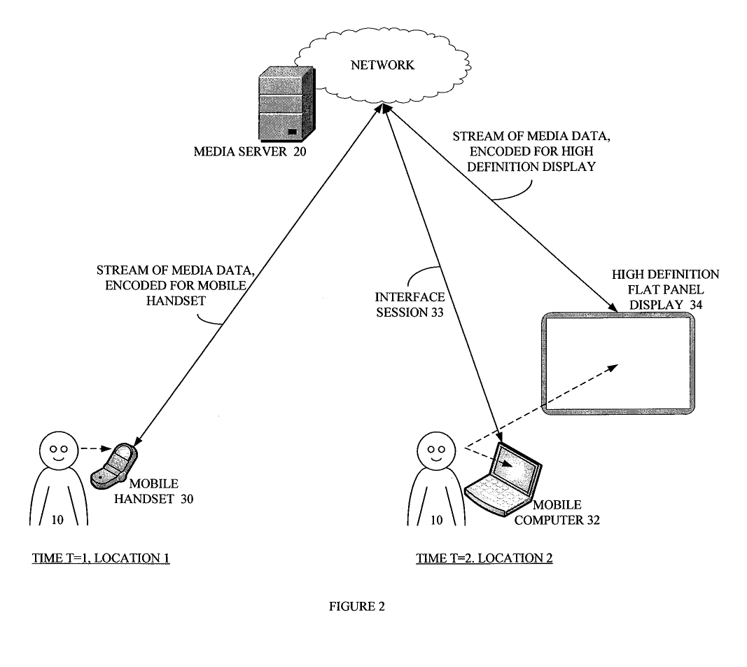

FIG. 2 is a block diagram illustrating one example (e.g., a use case) of how a media server 20 operates and interacts with various media player devices, consistent with an embodiment of the invention. As illustrated in FIG. 2, the user 10 is shown at two different times, for example, at time T=1 (in the left portion of the figure) and at a subsequent time, time T=2 (in the right portion of the figure). Furthermore, at time T=1, the user is in a first location, Location 1, while at time T=2, the user has relocated to a new location, Location 2. In this example, at time T=1 at Location 1, the user is operating his mobile handset 30. In particular, the mobile handset 30 is connected to the media server 20, which is streaming digital media content (e.g., a movie) to the mobile handset 30. Accordingly, at time T=1 the media server 20 is reading source digital media data and transforming the source digital media data to a format suitable for streaming to the mobile handset 30 at Location 1.

At the point in time T=2, the user arrives at a new location, for example, Location 2, which may be the user's home. When the user arrives at Location 2, the user (more precisely, the user's mobile handset) may send a command to the media server requesting that the stream of digital media data to the mobile handset 30 be stopped. The user may then use a mobile computer 32 to communicate a subsequent request to the media server 20 for the same media item the user was previously viewing on his mobile handset 30. However, in this example, the request may be communicated to the media server 20 from a mobile computer 32 over an interface session 33 established between the mobile computer 32 and the server 20, but the request indicates that the digital media data, representing the media item, is to be streamed to a high definition flat panel display 34. Accordingly, when the media server 20 receives the request, the media server 20 analyzes history information associated with the user's user profile. Based on the analyzed history information, the media server 20 determines where (e.g., at which scene in the movie) the user stopped viewing the media item on his mobile handset 30, and resumes streaming of the digital media data to the high definition flat panel display 34 at that particular portion or scene of the movie.

In some embodiments, the history information may include not only the relevant position (e.g., scene) of the media data where a user stopped viewing, but also a time indicating how long ago the user last viewed the requested media item. If, for example, the last viewing session occurred in the distant past (e.g., in a previous year), the media server 20 may stream the media item from its beginning. If, on the other hand, the last viewing session occurred only ten minutes prior to the new request for the media item being received at the media server 20, then the media server 20 may resume streaming the media item from the exact sequence where the user last stopped viewing. In some embodiments, this history information determines the exact location or sequence of the digital media data that is presented when a subsequent request to view the same media item is received. For instance, if a subsequent request is received three hours after a previous viewing session for a particular media item has ended, the media server 20 may resume streaming of the media item, in response to the subsequent request, at a location in the media item that repeats five to ten minutes of the digital media that was previously streamed. This will provide the user with an opportunity to refresh his memory as to what was being viewed just prior to the end of the viewing session. If, on the other hand, the subsequent request for the media item is received substantially immediately after the end of a previous viewing session, the media server may resume streaming at the exact location where the user stopped the previous viewing session.

Furthermore, when a subsequent request for the same media item is received at the media server, the request includes a device identifier, identifying the target device to which the digital media data is to be streamed. Accordingly, the media server 20 analyzes a device profile for the target device to identify the device attributes of the target device to which the digital media data is to be streamed. Based on this analysis, the media server transforms or converts the source digital media data for optimal presentation on the high definition display 34.

In some embodiments, location information for certain devices is communicated to the media server 20, thereby enabling the media server 20 to make intelligent decisions, based in part, on location information. For instance, in the example presented in FIG. 2, the mobile handset 30 may include a global positioning system (GPS) device, enabling the mobile handset to determine its position, and communicate location information to the media server 20. Accordingly, when the user relocates to Location 2, the mobile handset may automatically communicate the mobile handset's current location information to the media server 20. The media server 20 can analyze this location information to determine that the user (more precisely, the user's mobile handset 20) is in proximity with the high definition flat panel display 34. Consequently, the media server 20 can automatically prompt the user to indicate whether the user would like to resume streaming of the media item on the high definition display 34 in a higher quality format. Alternatively, the media server 20 may automatically switch to stream the movie to the flat panel display 34. In some embodiments, certain aspects of the behavior of the media server 20 may be configured by the user with configuration settings in a user preferences module (not shown).

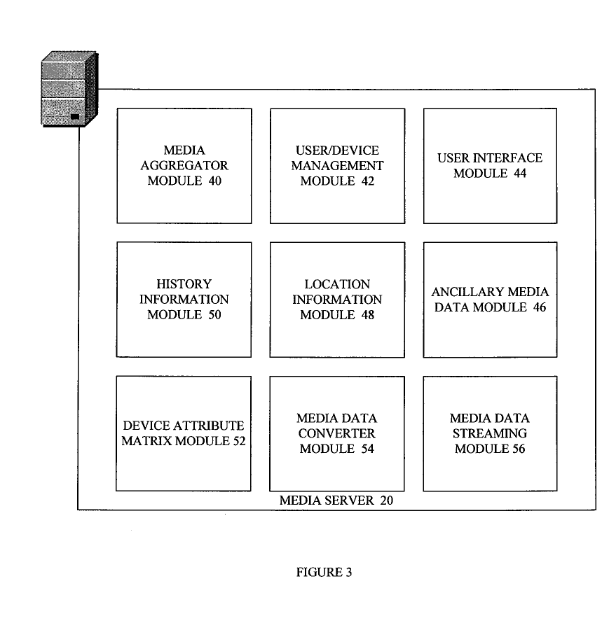

FIG. 3 is a functional block diagram of a media server 20 according to an embodiment of the invention. As illustrated in FIG. 3, the media server 20 includes a media aggregator module 40. As its name suggests, the media aggregator module 40 facilitates the aggregation of source digital media at the media server 20. For example, in some embodiments, users are able to upload media items to the media server 20 so that the media items can be streamed to any one of the user's media player devices. In addition, the media server 20 may have a catalog component (not shown), enabling users to purchase media items (e.g., movies, music, music videos, instructional videos, digital books, and so forth). In some embodiments, a purchased media item will be stored at the media server 20 and can be streamed to an appropriate media player device. Accordingly, the media aggregator module 40 may facilitate the uploading of digital media to the media server 20 by content owners and/or content providers. For instance, owners of digital media data who would like to offer media items for sale via the media server 20 may utilize the media aggregator module 40 to upload media data to the media server 20. In some embodiments, the aggregator module has a user interface that allows a content owner or content provider to specify prices, and provide descriptions of the digital content, and so forth.

The present invention is independent of any particular business model. As such, in some embodiments, media items may be offered for sale. When purchased, the media data comprising the media item may be downloaded to a particular device by the user and/or stored on the media server 20 so that it may be streamed to any device of the user. Alternatively, in some embodiments, the media items may be offered for rent, such that the purchase of a media item enables a user to stream the media item a limited number of times, or for a limited period of time. Other embodiments may implement hybrid systems where some media items are offered for sale, while others are offered for rent, and so forth. In some embodiments, the media server 20 may implement a system of digital rights management (DRM), while in other embodiments, no such DRM is utilized.

The media server 20 illustrated in FIG. 3 includes a user and device management module 42. In one embodiment, the user and device management module 42 facilitates the management of user and device information. For example, each user of the media server 20 may have a user profile, including a username and password. The user management module 42 may facilitate the storage of usernames and passwords, as well as perform an authentication process when users are requesting access to the media server 20. In some embodiments, associated with a user profile is each device that the user owns or utilizes with the media server 20. Accordingly, the device management module 42 facilities a device registration process whereby a user identifies his or her media player device to the media server 20. In some embodiments, this may be achieved by providing a unique device identifier for each device.

The media server 20 includes a user interface module 44. The user interface module 44 operates in conjunction with one or more other modules to facilitate the communication of data to various devices, where the data represents a user interface. In some embodiments, the user interface module 44 facilitates the communication of user interface data to media player devices such that the data, when processed and rendered at the media player devices, presents a user interface. For instance, in some embodiments, the user interface may operate in conjunction with a web server component (not shown) to facilitate a user interface via client-based web browser applications executing on the various media player devices. The types of user interfaces are varied. For instance, some user interfaces supported or provided by the user interface module 44 are suitable for mobile devices with small displays having relatively low display resolutions, while others will be suitable for larger displays. In addition, in some embodiments, user interfaces support the use of touch screens and gestures as data input mechanisms. The user interfaces provide a wide variety of functions as well. For instance, in some embodiments, the user interfaces provide a mechanism for enabling the selection of media items to be streamed. In some embodiments, the user interfaces will provide a mechanism for generating playlists, and/or adding and deleting media items to different user-generated categories, such as a favorites list. In addition, as described in connection with the ancillary media data module 46, in some embodiments, the user interface module facilitates the presentation of ancillary media data on the display of a device that is in proximity with another device, on which digital media data is being presented.

In some embodiments of the invention, the media server 20 and one or more media player applications executing on individual media player devices may be experienced on multiple display devices, for example, such that different, but related, media data is presented in a synchronized manner on more than one display, as part of a single viewing session. For example, in some embodiments, the ancillary media data module 46, in conjunction with the user interface module, facilitates the presentation of interactive content on the display of one media player device, while digital media data is streamed to, and presented, on the display of another device. Accordingly, a user can view a movie on a flat panel display while receiving content, associated with or related to the movie, on a laptop or mobile computing device. The ancillary data module 46 facilities the presentation of this ancillary media data on the second device. In particular, the ancillary media data module 46 facilities the selection of content that is associated with the media data being streamed to the primary viewing device. The ancillary media data may include hyperlinks, or the equivalent, that enable the user to select additional content for viewing. In some embodiments, the ancillary media data may be presented as a content specific search portal, which, for example, enables a user to search for specific information about a media item that is being viewed on the primary viewing device (e.g., the flat panel display in FIG. 2). In some embodiments, the ancillary media data module 46 may present ancillary media data on a secondary device, while a live event (e.g., a sporting event) is being streamed to, and presented on, a primary viewing device.

In some embodiments, the ancillary media data module 46 may facilitate the presentation of a control interface on a display of a secondary device. For example, a control interface may be presented on the display of a laptop while a movie is being presented on a flat panel display (e.g., a primary viewing device), thereby enabling the user to control play back functions of the media item being streamed to and presented on the flat panel display. In this example, by interacting with the control interface presented on the laptop, the user is able to pause, rewind, fast forward, and so forth, the presentation of the movie on the primary viewing device (e.g., the flat panel display).

As briefly described above, in some embodiments, the media server 20 will store and analyze a user's history information, as well as location information. Accordingly, the media server 20 illustrated in FIG. 2 is shown to include a history information module 50 as well as a location information module 48. In some embodiments, the history information module 50 monitors, and stores a user's viewing habits, for example, by keeping a record of what media items have been viewed, on which devices those media items have been viewed, in what format the media items were streamed, when the media items were viewed, and so on. Similarly, the location information module 48 receives and stores location information about the various devices utilized with the media server 20. In some cases, location information about a device may be manually provided by a user. For instance, a user may provide location information about stationary devices, such as flat panel displays, and/or desktop computers. In other cases, when a device includes support for location information services, the device itself may communicate the location information to the media server 20. For instance, a mobile handset or other mobile device with a global positioning system (GPS) device may determine its location, and then communicate the location information to the media server 20. Of course, other location identification mechanisms may be used. Accordingly, the location information module 48 may receive and analyze location information to make intelligent decisions on when and how media data are to be presented to a user. For example, location information may be analyzed for the purpose of selecting the media player device in a particular location that has the device attributes enabling the highest quality presentation of a requested media item. In such a scenario, if a request for a media item is received at the media server 20, the media server 20 may automatically stream the media item to the media player device with the best device attributes, or alternatively, the media server may indicate to the user that a particular device has better device attributes than the device initially selected by the user.

In some embodiments, when a request for a particular media item is received, the request includes a device identifier identifying the device to which the digital media data is to be streamed, and a media item identifier, identifying the media item being requested. In some cases, the device identifier may identify the device that is communicating the request for the media item, and in other cases, another target device may be identified. For instance, a mobile handset may communicate a request to the media server to have digital media data streamed to a flat panel display. In such a case, the device identifier of the flat panel display would be included in the request. Upon receiving the request, the media server 20 will ascertain the device attributes of the target device, for example, by analyzing a device profile of the target device. Then, the media data converter module 54 will convert the source digital media data to a format suitable for streaming to, and presentation on, the target device. Depending upon an analysis of historical information, the streaming of the media item may begin at the beginning of the media item, or at some previous point where a precious streaming session was ended. As illustrated in FIG. 3, the media server 20 includes a media data streaming module 56 for streaming media data to media player devices.

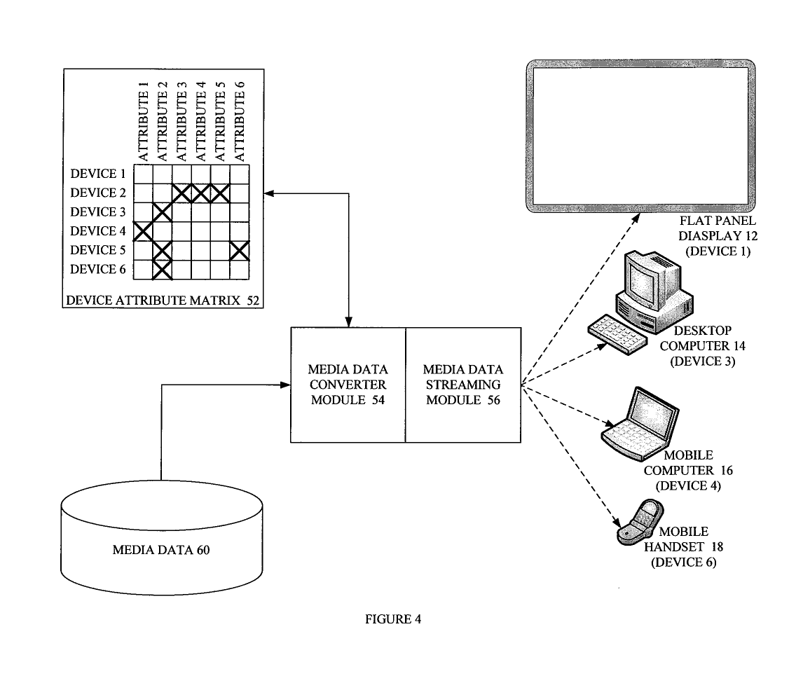

FIG. 4 is a block diagram illustrating various components involved in streaming digital media data to media player devices, according to an embodiment of the invention. In some embodiments, the device profile for each media player device is implemented as a device attribute matrix 52. In some embodiments, a device attribute matrix 52 exists for each user, such that the matrix only includes device attributes for the specific devices that have been registered or otherwise associated with that particular user. Alternatively, in some embodiments, a large matrix exists for all devices of all users. In any case, a device attribute matrix 52 may be a two dimensional matrix having rows, representing devices, and columns, representing device attributes. Accordingly, upon receiving a request to stream digital media data to a particular device, the row of the device attribute matrix 52 corresponding with the device identifier of the particular device can be identified, and the device attribute matrix 52 will indicate which device attributes are associated with or supported by the particular target device. For instance, as illustrated in FIG. 4, the mobile computer 16 corresponds with device identifier, “DEVICE 4.” From the row in the device attribute matrix 52 corresponding with device identifier, “DEVICE 4,” it can be seen that the mobile computer 16 supports the device attribute referred to as, “attribute 2.” If, for example, “attribute 2” represents WiFi, then the device attribute matrix 52 can be consulted to determine that the mobile computer 16 supports, or includes, WiFi.

Upon receiving a request to have a particular media item streamed to a particular device, the media server consults the device attribute matrix 52 to determine the device attributes of the target device. Once the device attributes of the target device are known, the media data converter module 54 reads source digital media data 60 from a media data repository, and converts the source digital media data to a format that best accommodates the target device, based at least in part on the analysis of the device attributes of the target device. In some embodiments, a network analyzer (not shown) may perform an analysis of network attributes for the communication network linking the media server with the target media player device. Accordingly, the media data converter module 54 may take into consideration network attributes and/or network conditions, when converting media data to be streamed to a target media player device. Once converted, the media data is streamed to the target device by the media data streaming module 56.

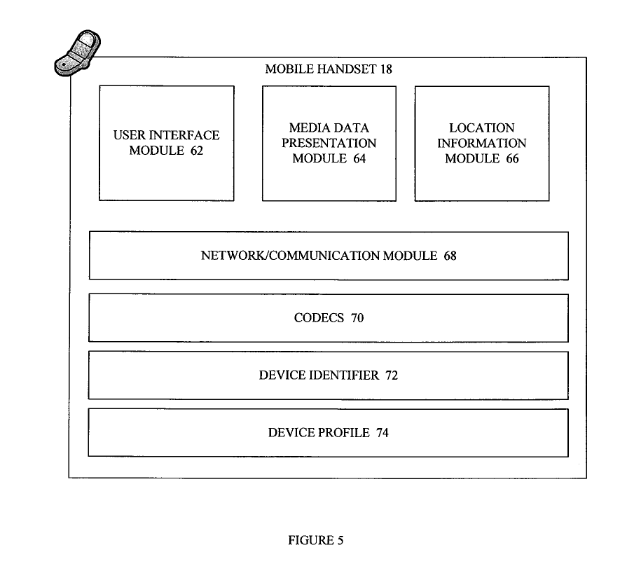

FIG. 5 is a block diagram illustrating various functional components of a media player device, according to an embodiment of the invention. As illustrated in FIG. 5, the media player device is a mobile handset 18. The mobile handset includes a user interface module 62, a media data presentation module 64, and location information module 66. The user interface module 62 facilitates the presentation of one or more user interfaces on a display of the mobile handset. In some embodiments, the user interface module 62 may operate in conjunction with the operating system of the handset, and a web browser client application (not shown) and/or the user interface module of the media server. However, in some embodiments, the user interface is implemented without a web-based application.

The media data presentation module 64 facilitates the presentation of media data after the media data has been received via the communication module 68 and decoded, for example, by one of the supported codecs 70. For example, in some embodiments, the media data presentation module 64 is the media player engine capable of playing various media data formats, either locally stored, or streamed to the mobile handset 18. In some embodiments, the mobile handset will include a GPS device, and location information module 66. In such a case, the location information module may periodically provide location information to the media server.

The mobile handset 18 is also shown to include a device identifier 72 and a device profile. In some embodiments, the device identifier 72 is a unique number assigned to the device by the manufacturer of the device, or alternatively, by an enterprise operating a media server service. In any case, the device identifier 72 may be used, for example, when the mobile handset 18 communicates a request for a media item. The device profile 74 may be automatically populated, for example, by an analysis of the various device attributes for the device. Alternatively, the device profile 74 may have one or more attributes that are established by a user of the device, for example, by manipulating one or more configuration settings for the device.

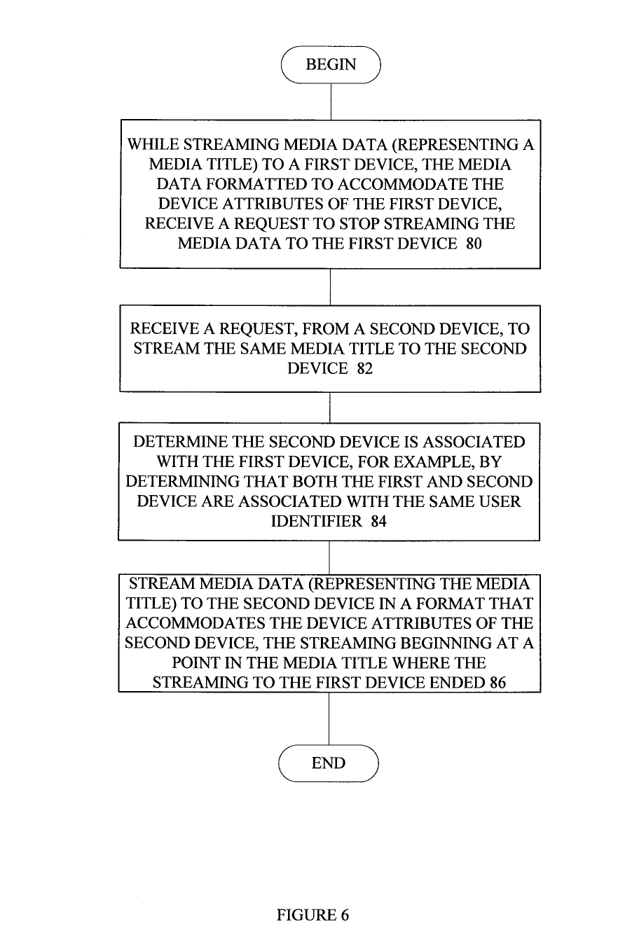

FIG. 6 illustrates a method, according to an embodiment of the invention, for streaming digital media. The method begins when, at method operation 80, while the media server is streaming media data, representing a media item, to a fist device (e.g., a mobile phone), the media server receives a request to stop streaming the media data. The request may be the result of the viewer manually selecting to generate the request to stop streaming. Alternatively, the request to stop streaming may be automatically generated as a result of the media server receiving location information indicating that the first device is in a location that the user has previously indicated a preference to have media streamed to a higher resolution display.

In any case, at method operation 82, a request for the same media item is received from a second device (e.g., a set-top box or flat panel display). The media server analyzes the request to determine the device identifier of the target device, where the media data is to be streamed. Next, at method operation 84, the media server determines that the second device is associated with the first device, for example, because both devices are associated with the same user. Finally, at method operation 86, the media data are converted to a format to accommodate the second device, and the media data are streamed to the second device, beginning with the particular media data, representing the portion (e.g., scene) of the media item, where the user stopped streaming to the first device.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or logics that operate to perform one or more operations or functions. The modules and logics referred to herein may, in some example embodiments, comprise processor-implemented modules or logics.

Similarly, the methods described herein may be at least partially processor-implemented. For example, at least some of the operations of a method may be performed by one or more processors or processor-implemented modules or logic. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

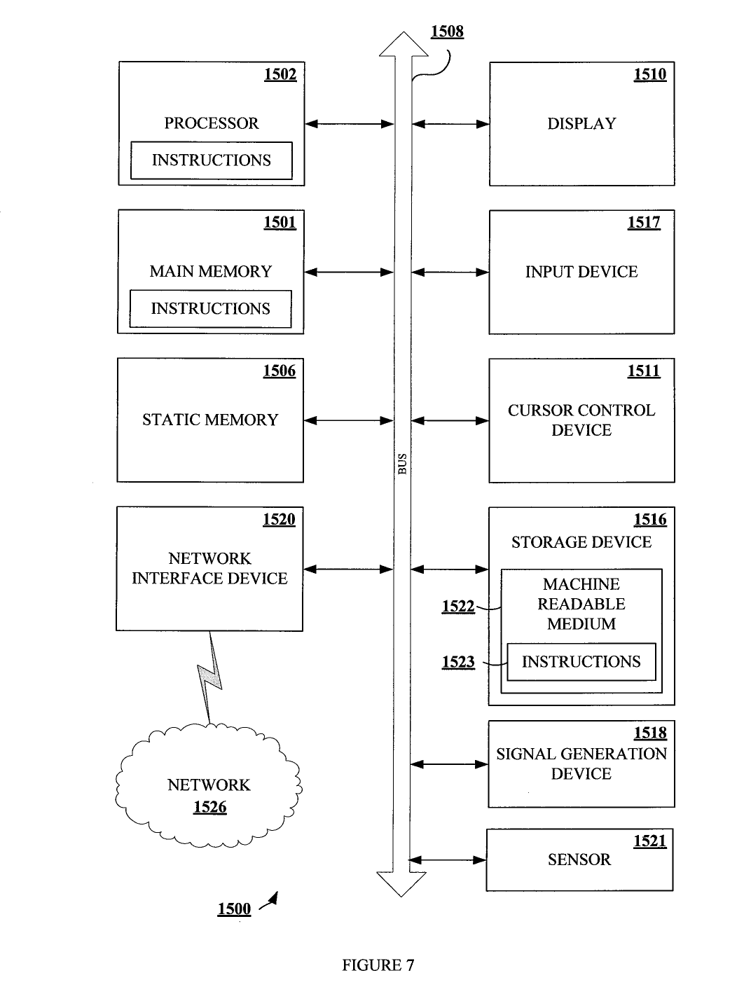

FIG. 7 is a block diagram of a machine in the form of a computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environments, or as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device (e.g., drive unit 1516), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A processor-implemented method comprising:
while streaming media data representing a media item to a first device in a first format suitable for presentation on a first device, receiving a request to stop streaming the media data to the first device;
receiving a request for the media item from a second device;
determining that the second device is associated with the first device;
streaming media data representing the media item to the second device in a second format suitable for presentation on a display of the second device by transforming the media data from a source format to the second format, the second format selected based, in part, on a device profile associated with the second device, the streaming media data resuming where presentation of the media data at the first device was previously stopped;
while streaming media data to the second device, receiving from a third device a request to establish a communication session;
determining that the third device is associated with the user identifier to which the first and second devices are associated; and
establishing the requested communication session with the third device, the communication session with the third device to facilitate a control interface session enabling i) selection, at a user interface of the third device, of available media items to be presented at the first and/or second device, and ii) selection, at a user interface of the third device, play back functions for a media item being presented on the first and/or second device.

2. The processor-implemented method of claim 1, wherein the request for the media item from the second device includes a device identifier, identifying the second device, and said determining that the second device is associated with the first device includes determining that the device identifier for the second device and a device identifier for the first device are both associated with a single user identifier.

3. The processor-implemented method of claim 1, wherein the request for the media item identifies the media item being requested and a device identifier identifying the device to which the media data is to be streamed.

4. (canceled)

5. The processor-implemented method of claim 1, wherein streaming media data to the second device in a second format suitable for presentation on a display of the second device includes transforming media data from a source format to the second format, the second format selected based, in part, on analysis of a communication connection over which the media data is streamed to the second device.

6. (canceled)

7. (canceled)

8. The processor-implemented method of claim 6, wherein the communication session with the third device facilitates an interface session, the interface session enabling i) interactive presentation of ancillary media data via a user interface presented on a display of the third device, the ancillary media data selected for its association with media data being presented at the second device.

9. The processor-implemented method of claim 1, wherein the request to stop streaming the media data to the first device is generated at, and received from, the first device.

10. The processor-implemented method of claim 1, wherein the request to stop streaming the media data to the first device is generated at a media server as a result of the media server receiving location information indicating an alternative device to which the media data is to be streamed.

11-20. (canceled)

21. A non-transitory computer-readable storage medium storing instructions thereon, which, when executed by a processor of a computing device, cause the computing device to:
while streaming media data representing a media item to a first device in a first format suitable for presentation on a first device, receive a request to stop streaming the media data to the first device;
receive a request for the media item from a second device;
determine that the second device is associated with the first device; and
stream media data representing the media item to the second device in a second format suitable for presentation on a display of the second device by transforming the media data from a source format to the second format, the second format selected based, in part, on a device profile associated with the second device, the streaming media data resuming where presentation of the media data at the first device was previously stopped;
while streaming media data to the second device, receive from a third device a request to establish a communication session;
determine that the third device is associated with the user identifier to which the first and second devices are associated; and
establish the requested communication session with the third device, the communication session with the third device to facilitate a control interface session enabling i) selection, at a user interface of the third device, of one or more media items to be presented at the first and/or second device, and ii) selection, at the user interface of the third device, play back functions for a media item being presented on the first and/or second device.

22. The computer-readable storage medium of claim 21, wherein the request for the media item from the second device includes a device identifier, identifying the second device, and said determining that the second device is associated with the first device includes determining that the device identifier for the second device and a device identifier for the first device are both associated with a single user identifier.

23. The computer-readable storage medium of claim 21, wherein the request for the media item identifies the media item being requested and a device identifier identifying the device to which the media data is to be streamed.

24. The computer-readable storage medium of claim 21, wherein streaming media data to the second device in a second format suitable for presentation on a display of the second device includes transforming media data from a source format to the second format, the second format selected based, in part, on analysis of a communication connection over which the media data is streamed to the second device.

25. (canceled)

26. (canceled)

27. The non-transitory computer-readable storage medium of claim 25, wherein the communication session with the third device facilitates an interface session, the interface session enabling i) interactive presentation of ancillary media data via a user interface presented on a display of the third device, the ancillary media data selected for its association with media data being presented at the second device.

28. The non-transitory computer-readable storage medium of claim 21, wherein the request to stop streaming the media data to the first device is generated at, and received from, the first device.

29. The non-transitory computer-readable storage medium of claim 21, wherein the request to stop streaming the media data to the first device is generated at a media server as a result of the media server receiving location information indicating an alternative device to which the media data is to be streamed.

30. The processor-implemented method of claim 8, wherein the media data being presented at the second device represents a movie and the ancillary media data represents information about the movie.

31. The non-transitory computer-readable storage medium of claim 26, wherein the media data being presented at the second device represents a live sporting event and the ancillary media data represents information about the live sporting event.
